(19) United States
(12) Patent Application Publication
(10) Pub. No.: US 2025/0377014 A1
(43) Pub. Date: Dec. 11, 2025

(54) BEARING DEVICE WITH INTEGRATED ELECTRICAL INSULATION, NOTABLY FOR AN ELECTRIC MOTOR OR MACHINE, AND ASSOCIATED MANUFACTURING METHODS

(71) Applicant: AKTIEBOLAGET SKF, GOTEBORG (SE)

(72) Inventors: Benoit ARNAULT, Saint-Cyr-sur-Loire (FR); Anthony SIMONIN, Tours (FR)

(21) Appl. No.: 19/220,281

(22) Filed: May 28, 2025

(30) Foreign Application Priority Data
Jun. 6, 2024 (FR) 2405939

(51) Int. Cl. F16C 19/04; F16C 19/52; F16C 33/58

(52) U.S. Cl. CPC F16C 19/04; F16C 19/52; F16C 33/583; F16C 2202/32; F16C 2220/60; F16C 2380/26

(57) ABSTRACT

A bearing device includes a bearing having first and second rings, a bushing and an electrically insulating insert overmolded between the bushing and the second ring. An axially facing end of the bushing includes a slot delimited by two lateral flanks and extending from the first cylindrical surface of the bushing to the second cylindrical surface of the bushing and a first protruding part of the electrically insulating insert extends into the at least one slot of the bushing, and an axially facing end of the second ring includes a slot delimited by two lateral flanks, the at least one slot of the second ring extending into the second ring from the second cylindrical surface of the second ring and a second protruding part of the electrically insulating insert extends into the at least one slot of the second ring.

### CROSS-REFERENCE

This application claims priority to French patent application no. 2405939 filed on Jun. 6, 2024, the contents of which are fully incorporated herein by reference.

### TECHNOLOGICAL FIELD

The present disclosure relates to the field of bearings that are used in particular in electric motors, electric machines and associated equipment.

### BACKGROUND

In an electric motor or machine, at least one rolling bearing is mounted between the housing of the electric motor or machine and the rotary shaft in order to support this shaft. During operation, when the shaft is rotating, a difference in electrical potential can occur between the shaft and the housing of the electric motor or machine, thereby generating an electric current between the inner ring of the rolling bearing, which is integral with the shaft, and the outer ring, which is integral with the housing. The electric current flowing through the components of the rolling bearing can damage these components, notably the rolling elements and raceways provided on the inner and outer rings. Electrical discharges can also generate vibrations.

To overcome these drawbacks, it is known to replace the rolling elements of the bearing, which are made of the same steel as the inner and outer rings, with rolling elements made of ceramic. The expression “hybrid rolling bearing” is then generally used. However, such a hybrid rolling bearing is relatively expensive.

In order to overcome the aforementioned drawbacks, it is also known to equip the outer ring of the rolling bearing with an insulating sleeve provided with a bushing and with an insulating insert made of electrically insulating material and interposed radially between the outer ring and the bushing. In order to attach the insulating insert to the outer ring and to the bushing without any additional elements or specific machining on the outer ring, the insulating insert can be overmolded. However, with such a solution, the insulating insert and the bushing may become detached from one another during operation.

### SUMMARY

The present disclosure therefore aims to overcome the aforementioned drawbacks by providing a bearing device which has a simple and economical design. the disclosure relates to a bearing device comprising a bearing having a first ring and a second ring configured to rotate relative to each other.

The device further comprises at least one insulating sleeve mounted on the second ring of the bearing. The insulating sleeve has a bushing and an insulating insert interposed radially between the second ring of the bearing and the bushing. The insulating insert is made of electrically insulating material.

The bushing comprises a cylindrical outer surface and a cylindrical inner surface, radially opposite the outer surface, which delimit the radial thickness of the bushing. The insulating insert is overmolded on the second ring of the bearing and at least on one of the outer and inner surfaces of the bushing.

According to a general feature, at least one first slot is provided on at least one of the bushing and the second ring. The first slot is delimited in the circumferential direction by two lateral flanks. According to another general feature, the insulating insert is also overmolded inside the first slot, covering the lateral flanks thereof.

This provides a bearing device that has integrated electrical insulation and is economical compared to conventional hybrid rolling bearings. Furthermore, the device is easy to manufacture and assemble in the associated electric motor or machine.

Moreover, the provision of the first slot on at least one of the bushing and the second ring of the bearing enables the bushing and/or the second ring to be made integral with the insulating insert in the circumferential direction. Indeed, the overmolded insulating insert covers the lateral flanks of the slot. The risk of relative movements between the insulating insert and the bushing and/or the second ring in the circumferential direction is limited, notably in the event of temperature variations.

“Circumferential direction” means the direction perpendicular both to the axial direction and to a radius of the bearing device, in other words tangential to a circle centered on the axis of the bearing device.

“Axial direction” means the direction parallel to the axis of the bearing device.

According to a first design, at least one first slot is provided only on the bushing. According to a second design, at least one first slot is provided only on the second ring of the bearing. According to a third particularly advantageous design, the second ring of the bearing and the bushing each comprise at least one first slot delimited in the circumferential direction by two lateral flanks, the insulating insert being overmolded inside each first slot and covering the lateral flanks of each first slot. In this case, the first slot of the second ring of the bearing can be located in the radial extension of the first slot of the bushing. Alternatively, the first slot of the second ring can be offset in the circumferential direction with respect to the first slot of the bushing.

The bushing may also comprise two opposite radial end faces which delimit the axial length of the bushing. Preferably, the first slot opens into one of the end faces of the bushing or of the second ring of the bearing.

In one embodiment, at least a first slot and a second slot are provided on at least one of the bushing and the second ring, each delimited in the circumferential direction by two lateral flanks. In this case, the insulating insert is also overmolded inside the first and second slots and covers the lateral flanks of each of the first and second slots. The first and second slots may be diametrically opposed.

If the insulating insert is made of a synthetic or elastomeric material, the device is less sensitive to temperature variations. In a particular embodiment, the bushing is made of metal. The bushing can thus be easily machined to a predetermined radial tolerance.

In one embodiment, the insulating insert covers the whole of the surface of the bushing. In this case, the insulating insert completely covers the surface of the bushing in the axial direction and in the circumferential direction.

According to a first design, the bushing delimits the outer surface of the device. In this case, the second ring is the outer ring of the bearing.

According to an alternative second design, the bushing delimits the inner surface of the device. In this case, the second ring is the inner ring of the bearing.

In a particular embodiment, the bearing comprises at least one row of rolling elements arranged between raceways of the first and second rings. The rolling elements may be made of metal.

The disclosure also relates to an electric motor comprising a housing, a shaft and at least one bearing device as defined above and mounted radially between the housing and the shaft.

The disclosure also relates to a method for manufacturing a bearing device as defined above, comprising the following successive steps: machining at least the first slot, mounting the bushing and at least the second ring of the bearing inside a manufacturing mold, and overmolding the insulating insert on the second ring, at least on the surface of the bushing and inside the first slot.

### BRIEF DESCRIPTION OF THE DRAWINGS

The present disclosure will be understood better from studying the detailed described of an embodiment, which is given by way of entirely non-limiting example and is illustrated in the appended drawings, in which:

FIG. 1 is an axial sectional view of a portion of a bearing device according to one exemplary embodiment of the disclosure.

FIG. 2 is an axial sectional of the bearing device of FIG. 1 through a different sectional plane.

FIG. 3 is a side elevational view of the bearing device of FIG. 1.

FIG. 4 is a perspective view of the bearing device of FIG. 1.

FIG. 5 is a partial exploded perspective view of the bearing device of FIG. 1.

FIG. 6 is a flowchart illustrating a method of manufacturing the bearing device of FIG. 1.

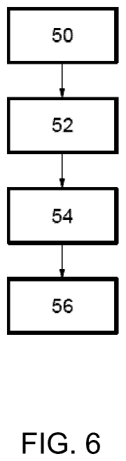

### DETAILED DESCRIPTION

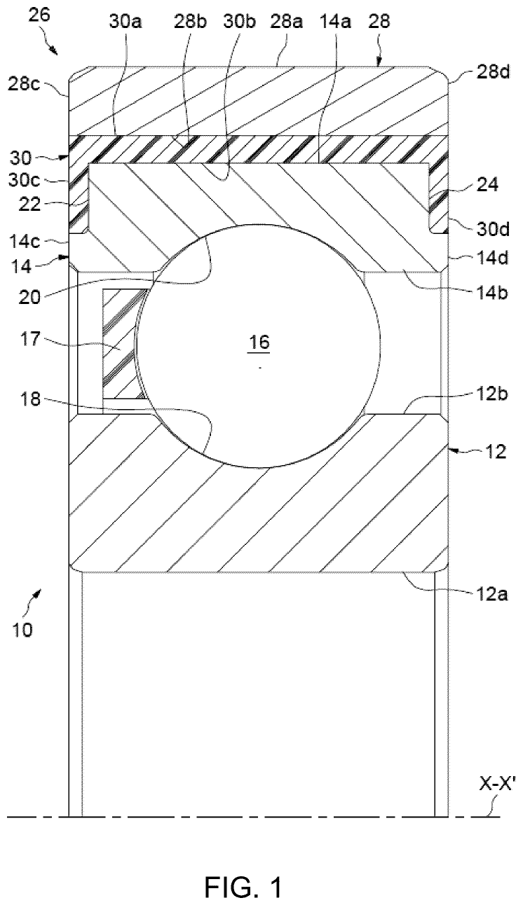

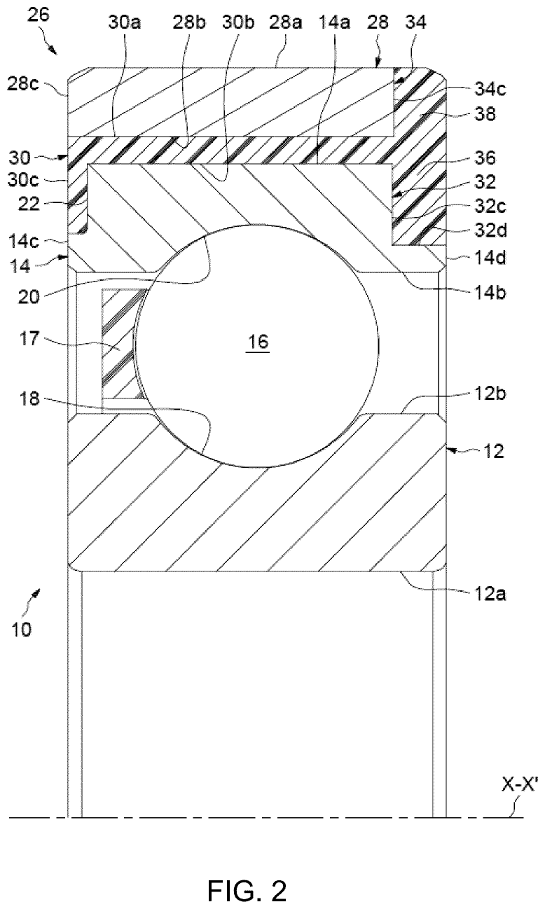

The bearing device illustrated in FIGS. 1 and 2 comprises a bearing 10 having a first ring 12 and a second ring 14 that are configured rotate relative to one another about the axis X-X′ of the bearing. In the exemplary embodiment illustrated, the first ring 12 is the inner ring of the bearing and the second ring 14 is the outer ring. The bearing device is designed such that it does not conduct electric currents. The bearing device has integrated electrical insulation.

The inner ring 12 and the outer ring 14 of the bearing are concentric and extend axially along the axis X-X′ of the bearing. The inner ring 12 and the outer ring 14 are made of steel. The rings are solid.

In the exemplary embodiment illustrated, the bearing 10 also comprises a row of rolling elements 16, in this case balls, interposed radially between the inner ring 12 and the outer ring 14. The rolling elements 16 are made of steel. The bearing 10 also comprises a cage 17 for maintaining the even circumferential spacing of the rolling elements 16. The bearing 10 can also be equipped with sealing flanges or gaskets.

The inner ring 12 comprises a cylindrical bore 12a, a cylindrical axially extending radial outer surface 12b radially opposite the bore, and two opposite radially extending axially facing end faces (not referenced) axially delimiting the bore and the outer surface. The bore 12a and the outer surface 12b delimit the radial thickness of the inner ring 12. The bore 12a forms the inner surface of the inner ring. The inner ring 12 also comprises an inner raceway 18 for the rolling elements 16 that is formed on the outer surface 12b. The raceway 18 is oriented radially outwards.

The outer ring 14 comprises a cylindrical axially extending outer surface 14a, a cylindrical bore 14b radially opposite the outer surface 14a, and two opposite radially extending, axially facing end faces 14c, 14d axially delimiting the bore. The outer surface 14a and the bore 14b delimit the radial thickness of the outer ring 14. The outer ring 14 further comprises an outer raceway 20 for the rolling elements 16 that is formed on the bore 14b. The raceway 20 is oriented radially inwards.

In the exemplary embodiment illustrated, a groove 22 is provided on the end face 14c of the outer ring. The groove 22 is oriented and open axially towards the outside of the outer ring. The groove 22 has a bottom that is axially offset towards the inside of the ring relative to the end face 14c. The bottom of the groove 22 forms a shoulder. The bottom of the groove 22 extends radially in this case for ease of manufacture. The groove 22 is annular in this case.

Similarly, a groove 24 is provided on the end face 14d of the outer ring. The groove 24 is oriented and open axially towards the outside of the outer ring. The groove 24 has a bottom that is axially offset towards the inside of the ring relative to the end face 14d. The bottom of the groove 24 forms a shoulder. The bottom of the groove 24 extends radially in this case. The groove 24 is annular in this case. The grooves 22, 24 are symmetrical with each other relative to a radial midplane of the outer ring. The grooves 22, 24 axially delimit the outer surface 14a. Alternatively, it could be possible not omit the grooves 22, 24.

The bearing device also comprises an electrically insulating sleeve 26 mounted on the outer ring 14. The insulating sleeve 26 is mounted on the outer surface 14a of the outer ring 14. The insulating sleeve 26 is integral with the outer ring 14.

The insulating sleeve 26 comprises a bushing 28 and an insulating insert 30 interposed radially between the outer ring 14 and the bushing 28. The insulating insert 30 is overmolded on the outer ring 14 and on the bushing 28.

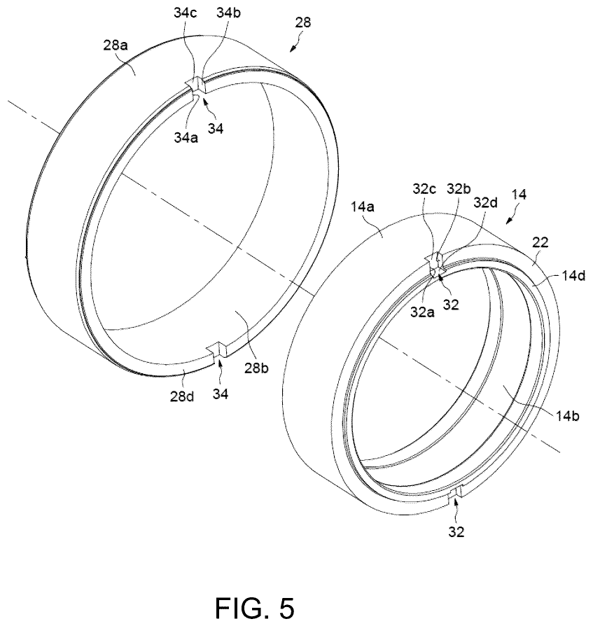

As visible notably in FIG. 5, two slots 32 are formed on an axially outer side of the outer ring 14 and two slots 34 are formed on the axially outer side of the bushing 28 to constrain the insulating insert to rotate with the bushing and with the outer ring.

In the exemplary embodiment, the slots 32 are identical to each other and are diametrically opposed. Alternatively, the outer ring 14 could comprise a single slot 32, or else at least three slots 32. Each slot 32 is radially open to the outer surface 14a of the outer ring and axially open to the end face 14d. Each slot 32 is open axially outwards. Each slot 32 is oriented and open radially outwards.

Each slot 32 is delimited in the circumferential direction by two lateral flanks 32a, 32b which are connected together by a radially extending axially facing bottom 32c. The lateral flanks 32a, 32b in this case face each other in the circumferential direction. In a variant, if the circumferential dimension of each slot 32 is greater, the lateral flanks 32a, 32b need not face each other.

In the exemplary embodiment illustrated, each slot 32 also comprises an radially facing bottom 32d which is connected to the flanks 32a, 32b and to the axially facing bottom 32c. Alternatively, each slot 32 could have no radially facing bottom 32d and could thus open radially into the bore 14b of the outer ring.

The flanks 32a, 32b of each slot are in this case rectilinear and extend radially for reasons of simplicity of manufacture. Alternatively, the flanks 32a, 32b of each slot could be differently shaped, for example not parallel, dovetail-shaped, stepped profile, etc. The radial bottom 32c also extends radially and is oriented axially outwards. Alternatively, each slot 32 could have no bottom, with the flanks 32a, 32b being joined directly together.

The bushing 28 is annular. The bushing 28 extends axially. The bushing 28 is formed in one piece in this case. Alternatively, the bushing 28 could be made of multiple parts bearing against one another, for example two identical parts. The bushing 28 comprises a cylindrical annular axial outer surface 28a, and an annular bore 28b which is radially opposite the outer surface 28a. The bore 28b forms the inner surface of the bushing 28.

With reference again to FIGS. 1 and 2, the bore 28b of the bushing is oriented radially inwards, i.e. towards the outer ring 14 and the insulating insert. The bushing 28 also comprises two opposite radially extending end faces 28c, 28d axially delimiting the bore and the outer surface. The end faces 28c, 28d delimit the axial length of the bushing. The cylindrical outer surface 28a and the bore 28b delimit the radial thickness of the bushing 28. The outer surface 28a of the bushing delimits the outer surface of the bearing device 10. In other words, the outer surface 28a defines the outer diameter of the bearing device 10.

In the exemplary embodiment illustrated, the end faces 28c, 28d of the bushing are coplanar with the end faces 14c, 14d of the outer ring, respectively. Alternatively, other arrangements could be provided. For example, the bushing 28 could have a smaller or greater axial dimension and be axially set back from the faces 14c, 14d of the outer ring, or could project from the faces.

With reference again to FIG. 5, each slot 34 extends to the bore 28b of the bushing and opens into the axially facing end face 28d. Each slot 34 is oriented and open axially outwards. Each slot 34 opens radially into the bore 28b of the bushing. In the exemplary embodiment illustrated, each slot 34 also opens radially into the outer surface 28a of the bushing. Alternatively, each slot 34 need not open into the outer surface 28a.

Each slot 34 is delimited in the circumferential direction by two lateral flanks 34a, 34b which are connected together by a radial bottom 34c. The lateral flanks 34a, 34b in this case face each other in the circumferential direction. In a variant, if the circumferential dimension of each slot 34 is greater, the flanks 34a, 34b need not face each other.

The flanks 34a, 34b of each slot are in this case rectilinear and extend radially for reasons of simplicity of manufacture. Alternatively, the flanks 34a, 34b of each slot could be differently shaped, for example not parallel, dovetail-shaped, stepped profile, etc. The axially facing bottom 34c also extends radially and is oriented axially outwards. Alternatively, each slot 34 could have no bottom, with the flanks 34a, 34b being joined directly together.

In the exemplary embodiment, the slots 34 are identical to each other and diametrically opposed. Alternatively, the bushing 28 could comprise a single slot 34, or else at least three slots 34.

The insulating insert 30 is made of electrically insulating material. The insulating insert 30 can for example be made of a synthetic material, such as PEEK or PA46, or else be made of an elastomeric material, such as rubber.

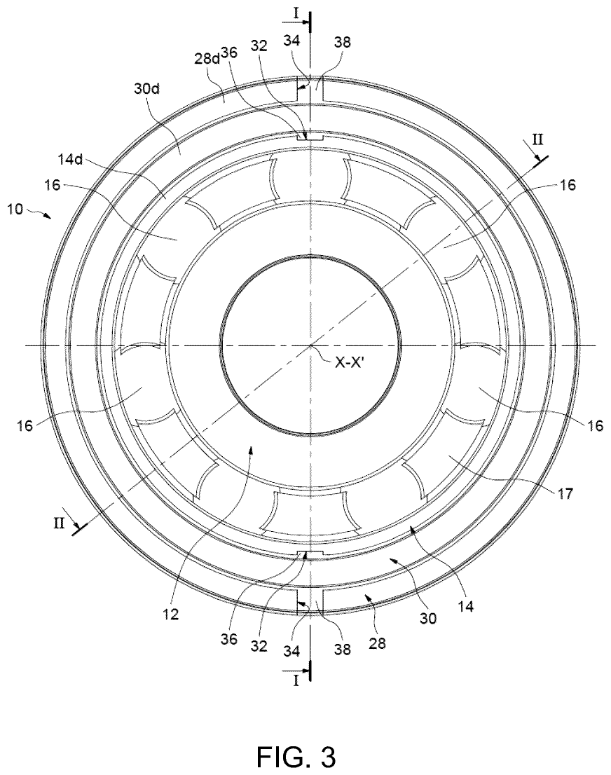

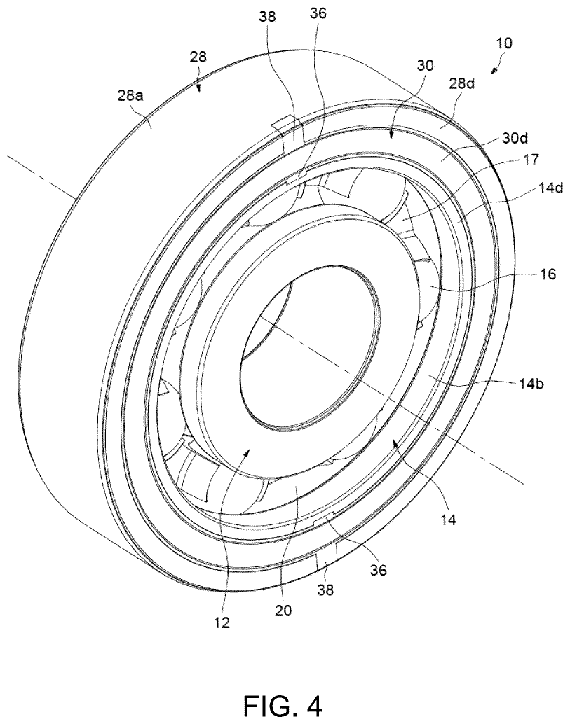

With reference to FIGS. 1 to 4, the insulating insert 30 is interposed radially between the outer surface 14a of the outer ring and the bore 28b of the bushing. The insulating insert 30 covers the outer surface 14a of the outer ring. The insulating insert 30 in this case entirely covers the outer surface 14a in the axial and circumferential directions. The insulating insert 30 also covers the grooves 22, 24 of the outer ring. The insulating insert 30 also covers the slots 32 of the outer ring. The insulating insert 30 covers the flanks, the axial bottom and the radial bottom of each of the slots 32.

The insulating insert 30 also covers the bore 28b of the bushing. The insulating insert 30 in this case also entirely covers the bore 28b in the axial and circumferential directions. The insulating insert 30 also covers the slots 34 of the bushing. The insulating insert 30 covers the flanks and the bottom of each of the slots 34.

The insulating insert 30 is annular. The insulating insert 30 extends axially. The insulating insert 30 comprises a cylindrical axially facing outer surface 30a, a cylindrical bore 30b radially opposite the outer surface 30a, and two opposite radially extending axially facing end faces 30c, 30d axially delimiting the bore and the outer surface. The radially facing end faces 30c, 30d delimit the axial length of the insulating insert 30.

In the exemplary embodiment illustrated, the faces 14c, 30c, 28c and 14d, 30d, 28d of the outer ring, of the insulating insert and of the bushing are respectively coplanar. As an alternative, other arrangements can be provided. For example, the insulating insert 30 could have a reduced axial dimension and be axially set back from the faces 14c, 14d of the outer ring. Alternatively, the insulating insert 30 could have a greater axial dimension and axially project from the faces 14c, 14d of the outer ring. In this case, the insulating insert 30 can at least partially cover these faces 14c, 14d. As a variant, the insulating insert 30 could at least partially cover the faces 28c, 28d of the bushing.

In another alternative, or in combination, the bushing 28 could axially project from the insulating insert 30 relative to the faces 30c and 30d, or could be axially set back from these faces.

The outer surface 30a of the insulating insert is in radial contact with the bore 28b of the bushing. The bore 30b is in radial contact with the outer surface 14a of the outer ring and with the grooves 22, 24.

The parts of the insulating insert 30 which cover the slots 32 of the outer ring of the bearing form two protuberances 36 which extend radially inwards. The protuberances 36 extend radially inwards from the bore 30b.

Each protuberance 36 is located inside one of the slots 32. Each protuberance 36 matches the shape of the associated slot 32. Each protuberance 36 bears against the flanks 32a, 32b of the associated slot in the circumferential direction. Each protuberance 36 bears axially against the radial bottom 32c and bears radially against the axial bottom 32d of the associated slot.

The parts of the insulating insert 30 which cover the slots 34 of the bushing form two protuberances 38 which extend radially outwards. The protuberances 38 extend radially outwards from the outer surface 30a.

Each protuberance 38 is located inside one of the slots 34. Each protuberance 38 matches the shape of the associated slot 34. Each protuberance 38 bears against the flanks 34a, 34b of the associated slot in the circumferential direction. Each protuberance 38 bears axially against the radial bottom 32c of the associated slot. Each protuberance 38 is radially flush with the outer surface 30a of the bushing.

In the exemplary embodiment illustrated, the protuberances 36 are flush with the end face 14d of the outer ring and the protuberances 38 are flush with the end face 28d of the bushing. Alternatively, the protuberances 36, 38 could be set back from the end faces 14d, 28d of the outer ring and the bushing, or project axially from these faces.

The bearing device is manufactured as follows.

In a first step 50 illustrated schematically in FIG. 5, the slots 32 and 34 of the outer ring 14 of the bearing and the bushing 28 are machined.

In a second successive step 52, the bearing 10, or just the outer ring 14, and the bushing 28 are mounted inside a mold that is provided for overmolding the insulating insert 30. In this position mounted inside the mold, the bushing 28 is radially spaced apart from the outer ring 14 of the bearing.

In a third successive step 54, the insulating insert 30 is overmolded both on the outer ring 14 of the bearing and on the bushing 28. The protuberances 36, 38 are formed during this step. The insert 30 and the protuberances 36, 38 form a one-piece assembly.

Then, in a fourth and final step 56, the unitary assembly formed by the bearing 10, or just the outer ring 14, the bushing 28, and the insulating insert 30 is extracted from the mold.

In the exemplary embodiments illustrated, the first ring 12 of the bearing is the inner ring and the second ring 14, on which the insulating insert 30 is overmolded, is the outer ring.

Alternatively, an inverted arrangement may be used, in which the second ring 14, on which the insulating insert 30 is overmolded, is the inner ring. In this case, the insulating sleeve is located in the bore 12a of the inner ring. The insulating insert is then interposed radially between the bore 12a of the inner ring and the outer surface of the bushing. The insulating insert is overmolded on the inner ring and at least on the outer surface of the bushing. The bore of the bushing delimits the bore of the bearing device.

In the described exemplary embodiments, the bearing of the device is provided with a single row of rolling elements. As a variant, the bearing can be provided with several rows of rolling elements. In addition, the rolling bearing may comprise types of rolling elements other than balls, for example rollers. In another variant, the bearing may be a plain bearing with no rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulated bearing devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other, the second ring having a first cylindrical surface and a second cylindrical surface radially spaced from the first cylindrical surface,
a bushing having an axial length and a first cylindrical surface and a second cylindrical surface radially spaced from the first cylindrical surface of the bushing, and
an electrically insulating insert overmolded between and connecting the first cylindrical surface of the bushing and the second cylindrical surface of the second ring,
wherein an axially facing end of the bushing includes at least one slot delimited in a circumferential direction by two lateral flanks, the at least one slot of the bushing extending from the first cylindrical surface of the bushing to the second cylindrical surface of the bushing and a first protruding part of the electrically insulating insert extends into the at least one slot of the bushing, and
wherein an axially facing end of the second ring includes at least one slot delimited in a circumferential direction by two lateral flanks, the at least one slot of the second ring extending into the second ring from the second cylindrical surface of the second ring and a second protruding part of the electrically insulating insert extends into the at least one slot of the second ring.

2. The bearing device according to claim 1,
wherein the lateral flanks of the at least one slot of the bushing face one another in the circumferential direction.

3. The bearing device according to claim 1,
the at least one slot of the bushing comprises a first slot of the bushing and a second slot of the bushing, and
wherein the at least one slot of the second ring comprises a first slot of the second ring and a second slot of the second ring.

4. The bearing device according to claim 3,
wherein the first slot of the bushing and the second slot of the bushing are diametrically opposed, and
wherein the first slot of the second ring and the second slot of the second ring are diametrically opposed.

5. The bearing device according to claim 1,
wherein the at least one slot of the bushing is radially aligned with the at least one slot of the second ring.

6. The bearing device according to claim 1,
wherein the at least one slot of the second ring extends from the second cylindrical surface of the second ring to the first cylindrical surface of the second ring.

7. An electric motor comprising:
a housing,
a shaft, and
at least one bearing device according to claim 1 mounted radially between the housing and the shaft.

8. A method for manufacturing the bearing device according to claim 1, comprising:
machining the at least one slot in the bushing,
machining the at least one slot in the second ring,
mounting the bushing and the second ring inside a manufacturing mold, and
overmolding the insulating insert on the bushing and the second ring and in the at least one slot of the bushing and in the at least one slot of the second ring.
